(19) United States
(12) Patent Application Publication
(10) Pub. No.: US 2022/0117175 A1
(43) Pub. Date: Apr. 21, 2022

(54) WICK INSERTING DEVICE AND AUTOMATED HANDLING SYSTEM

(71) Applicant: Waterwick B.V., 's-Gravendeel (NL)

(72) Inventor: Anthony VISSER, 's-Gravendeel (NL)

(73) Assignee: Waterwick B.V., 's-Gravendeel (NL)

(21) Appl. No.: 17/285,159

(22) PCT Filed: Sep. 9, 2019
(86) PCT No.: PCT/NL2019/050582

§ 371 Date: Apr. 14, 2021

(30) Foreign Application Priority Data
Oct. 16, 2018 (NL) 2021818

(51) Int. Cl. A01G 27/06

(52) U.S. Cl. CPC A01G 27/06

(57) ABSTRACT

A wick inserting device for better automated handling, and an automated handling system, as well as an assembly of a pot and a wick inserting device and an assembly of a plurality of interconnected wick inserting devices. The wick inserting device includes an elongate body dimensioned to pass through a hole in a bottom or a sidewall of a plant pot, a wick clamp or jaw at one end of the elongate body configured to engage a length of a wick, and a stop head at an opposing end of the elongate body.

The present disclosure relates to a wick inserting device.

Present day wick inserting devices need to be manually inserted into plant pots, after manually attaching a length of wick thereto. This is labour intensive and consequently costly, and therefore less desirable. The inventors of the present disclosure have set out to develop a wick inserting device that is better suitable for automation, and to this end have developed a wick inserting device, comprising
an elongate body dimensioned to pass through a hole in a bottom or a sidewall of a plant pot;
a wick clamp or jaw at one end of the elongate body configured to engage a length of a wick; and
a stop head at an opposing end of the elongate body.

Preferably, the stop head comprises at least one passage to allow wick to pass there along, for example to a water reservoir.

Preferably, the device further comprises an additional wick clamp or jaw at the head stop and configured to engage another portion of the length of the wick.

Preferably, the stop head is larger, transverse to the lengthwise direction of the elongate body, than the elongate body. In such an embodiment, the transverse size of the stop head is preferably sufficiently large to cover the hole and thereby prevent the stop head from being pressed through the hole in the bottom or sidewall of the plant pot.

Preferably, the elongate body comprises at least one resilient leg. Then, the resilient leg preferably diverges from a connection point with the elongate body towards stop head. The resilient leg may be made sufficiently flexible to deflect and align with or lie closer to or against the elongate body, for the resilient leg to entirely pass the through hole in the plant pot, and to flex or revert thereafter back towards the undeflected position thereof. Additionally or alternatively, the resilient leg comprises at least one outward oriented rib. Then, the rib preferably forms a hook.

Preferably, at least one of the elongate body; the wick clamp or jaw; and the stop head is at least partially manufactured from bio-degradable material.

The present disclosure also relates to an assembly, comprising:
a plant pot having a hole in a bottom or a sidewall thereof;
a wick inserting device according to any of the preceding claims, of which the elongate body is inserted at least substantially fully through the hole for the stop head to at least approximate and preferably cover the hole;
a wick engaged by the wick clamp or jaw at the one end of the elongate body, and extending from the wick clamp or jaw at least towards the stop head.

The present disclosure also relates to an assembly, comprising at least a pair of the wick inserting devices according to any of the preceding claims, wherein neighbouring wick inserting devices are connected by a cross bar, which extends radially relative to the longitudinal direction of the elongate bodies and between wick inserting devices. Even though the thus formed strip of wick inserting devices comprises cross bars between the devices, which are to be removed before insertion into plant pots and form waste after wick inserting devices are singularized for inserting, the formed cross bar connections allow improved and accelerated processing at lower costs than when individual wick inserting devices are supplied to a system for inserting, wherein thus achieved benefits far outweigh the disadvantage of waste and the waste cross bars may even be recycled. Moreover, strips of wick inserting devices can be transported in a more space efficient manner than single wick inserting devices, and can be singularized immediately before inserting into plant pots or stored and possibly even transported further before being inserted automatically or manually into plant pots.

Preferably, attached to at least one of the cross bars is a transport arm. Then, the transport arm preferably extends in at least one direction from the cross bars transverse relative to the longitudinal direction of strip.

Preferably, the cross bar is disconnectable from both elongate bodies of the neighbouring wick inserting devices, at a position close to the elongate bodies and preferably at the elongate bodies, to prevent remnants of the cross bar from forming an obstacle when inserting the wick inserting devices through holes in bottoms or sidewalls of plant pots, wherein the cross bar may be connected to elongate bodies at a weakening, such as a tear line, perforation, thinning portion and the like, to in advance at least approximately determine a location of disconnection.

The present disclosure also relates to a system configured for handling and/or manipulating assemblies of above identified wick inserting devices, comprising
a transporter engaging the assemblies of wick inserting devices and promoting the assemblies towards
a disconnector configured to singularize neighbouring wick inserting devices;
an applicator configured to apply a length of wick to at least one of the wick inserting devices; and
a manipulator configured to engage an individual singularized wick inserting device and insert it with the wick into a hole in a bottom or a side wall of a plant pot.

Preferably, and when a transport arm is provided, the disconnector comprises a cutter and the transporter is configured to support the transport arm at least when the cutter is operative to disconnect the cross bar from the elongate body or vice versa.

Preferably, the manipulator comprises a gripper configured to engage a wick inserting device.

Preferably, the system further comprises at least one of: a punch to strike the hole in the bottom or the sidewall of the plant pot at a predetermined position; a rotator to turn the plant pot and to thus position the hole at a predetermined position; and a supply of the plant pot in a sequence with preceding and following plant pots, all with the hole thereof at a predetermined position, to allow the manipulator to orient the wick inserting device on the hole at the predetermined position. Then, the supply may comprise a conveyor with an articulated plant pot support wherein the plant pot is correspondingly articulated to rotationally orient the plant pot based on the articulation of the support and the corresponding articulation of the plant pot and position the hole at the predetermined position. Then, the conveyor may comprise at least one transport tray with at least one accommodation for the plant pot and the accommodation comprises the articulation. Additionally or alternatively, a side wall of the pot may comprise the articulation up to an upper rim, and defines a support for a watering insert.

Following the foregoing indication of features of embodiments of the present disclosure in runner generic terms, corresponding with the wordings of the appended claims, herein below exemplary embodiments will be disclosed in more technical detail, referring to the appended drawings, where it is noted, that the scope of protection for the present disclosure is by no means to be limited to specific features of the following description or in the appended drawings, unless the appended independent claims are limited to such features and where it is further noted that even equivalent features relative to those defined in the independent claims are potentially also encompassed by the scope of protection. In the appended drawing:

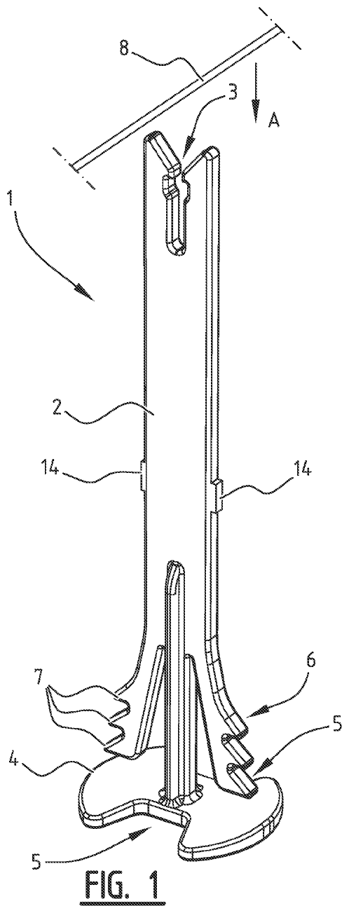

FIG. 1 shows a wick inserting device for introducing a wick into a plant pot having at least one bottom or side hole;

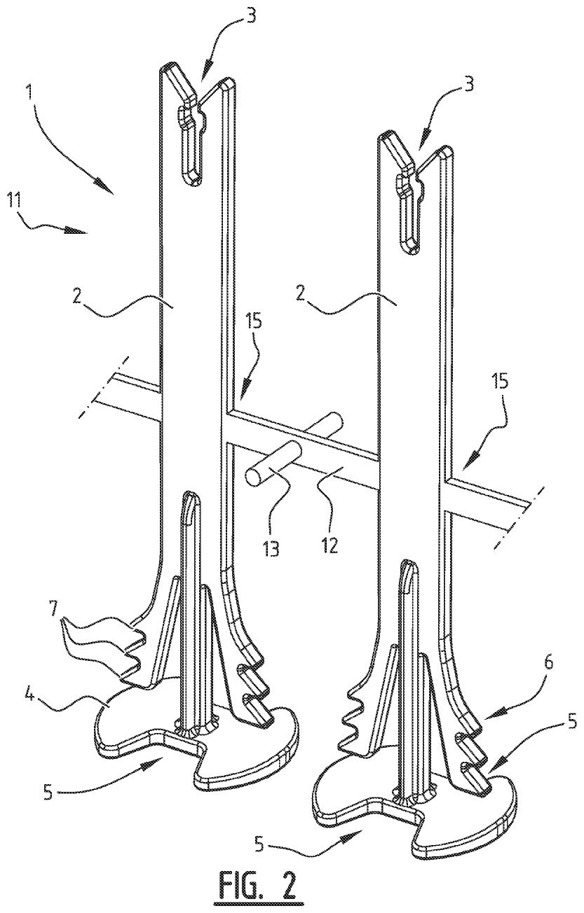

FIG. 2 shows a pair of mutually connected wick inserting devices in a strip, with the one of FIG. 1 broken or cut from the strip;

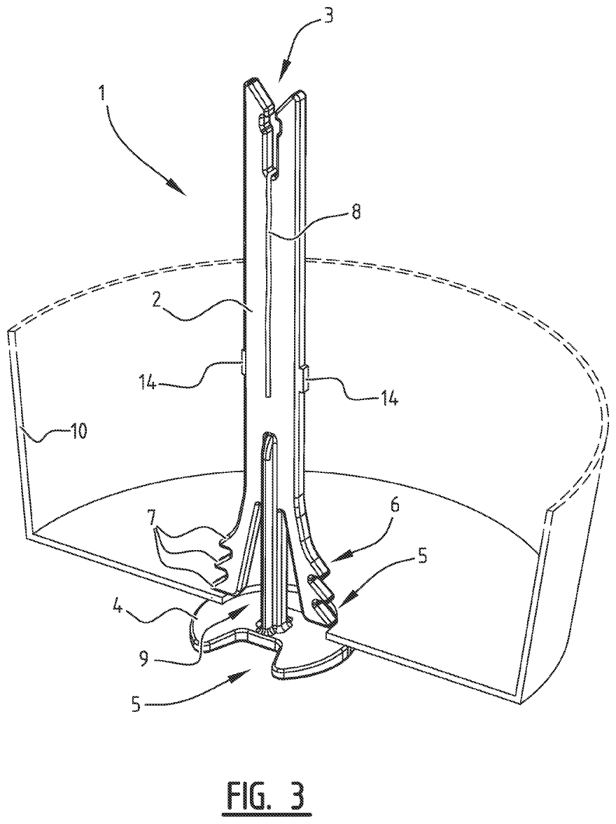

FIG. 3 shows a wick inserting device singularized from the strip of FIG. 2 and inserted into a plant pot;

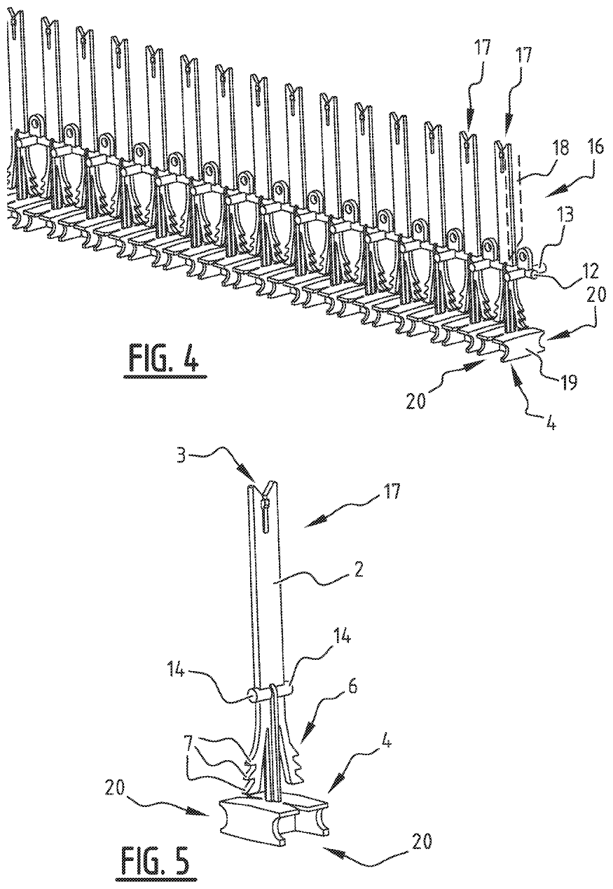

FIG. 4 shows a strip of mutually connected wick inserting devices in another embodiment;

FIG. 5 shows a singularized wick inserting device, after is has been singularized or liberated from the strip of FIG. 4;

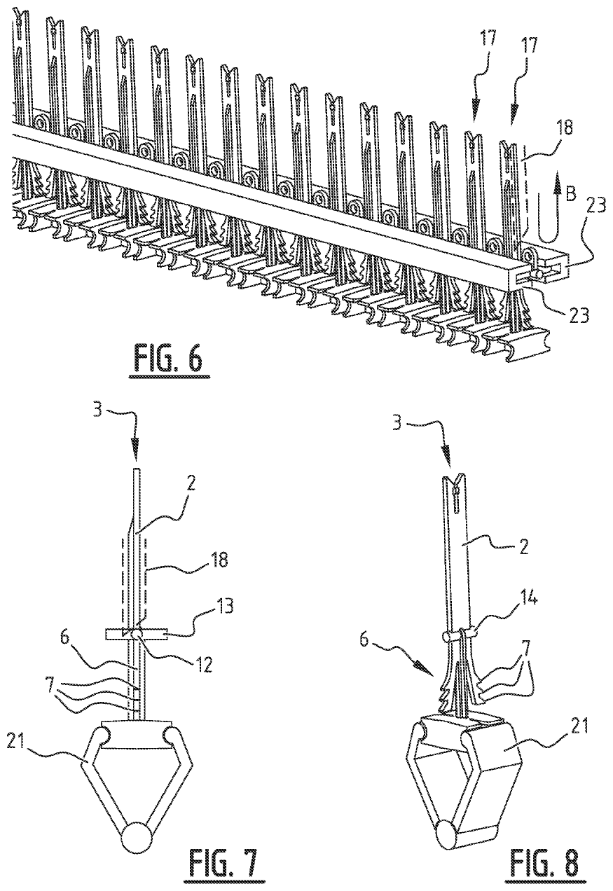

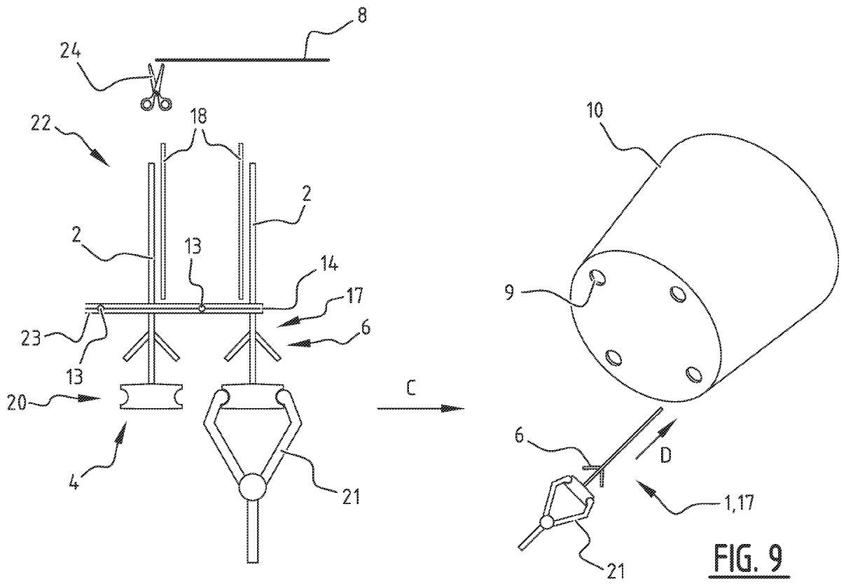

FIG. 6 shows a portion of a transporter of a system of FIG. 9;

FIGS. 7 and 8 show a portion of a gripper of a system of FIG. 9, engaging a singularized wick inserting device of FIG. 5;

FIG. 9 shows a schematic representation of the system for handling strips of wick inserting devices;

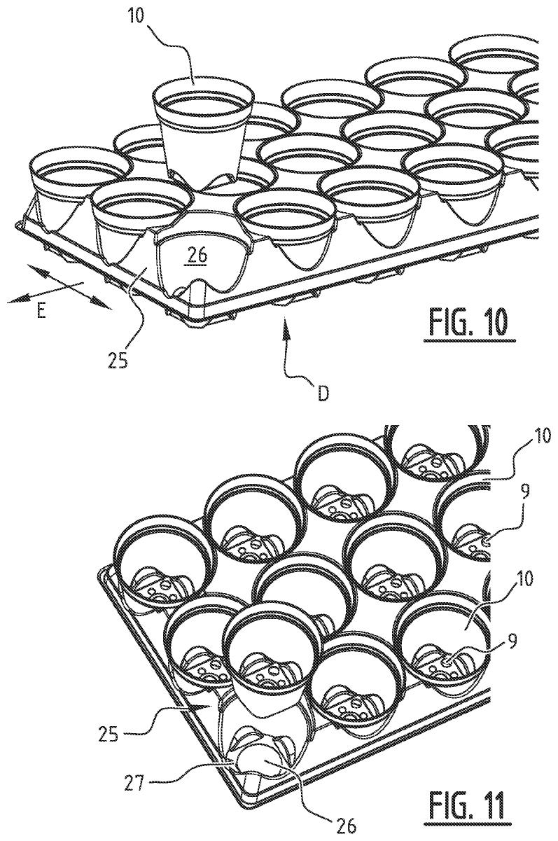

FIGS. 10, 11 show an assembly of tray and pot to define a supply in the sense of the present disclosure;

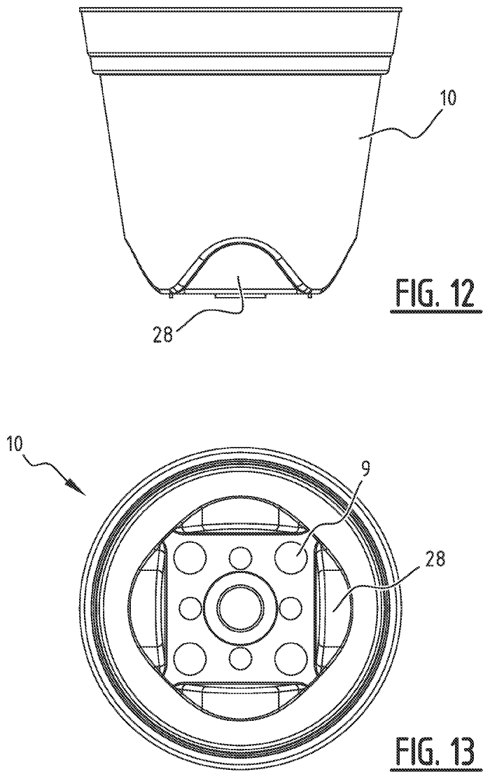

FIGS. 12, 13 show an exemplary pot of or for the assembly in FIGS. 10, 11;

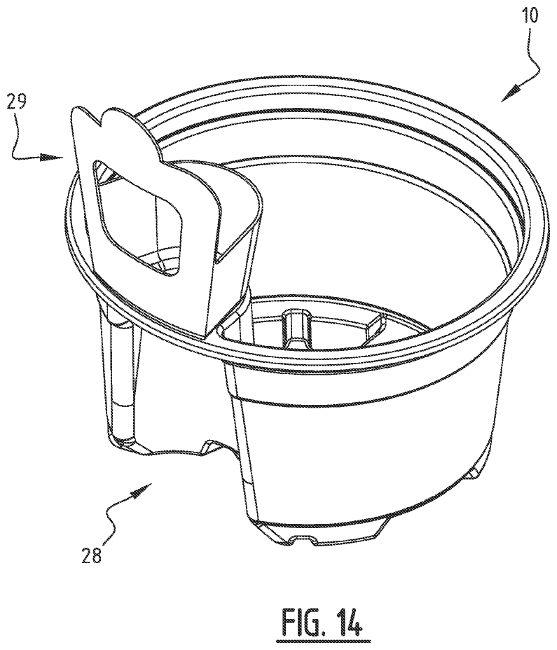

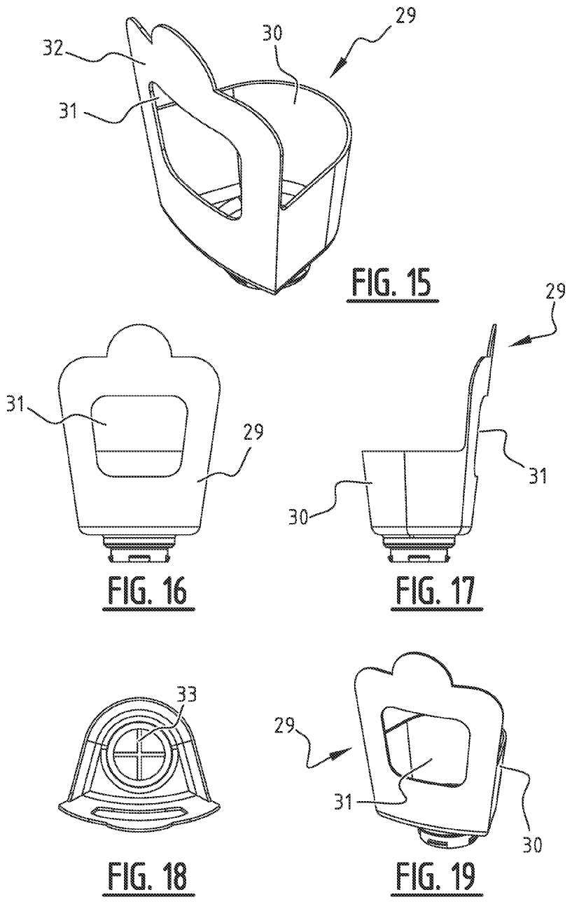

FIGS. 14-19 show an alternatively configured articulation of the pot that enables both alignment of holes in bottoms of pots with insertion of a wick inserting device and provide support for a watering insert of FIGS. 15-19; and

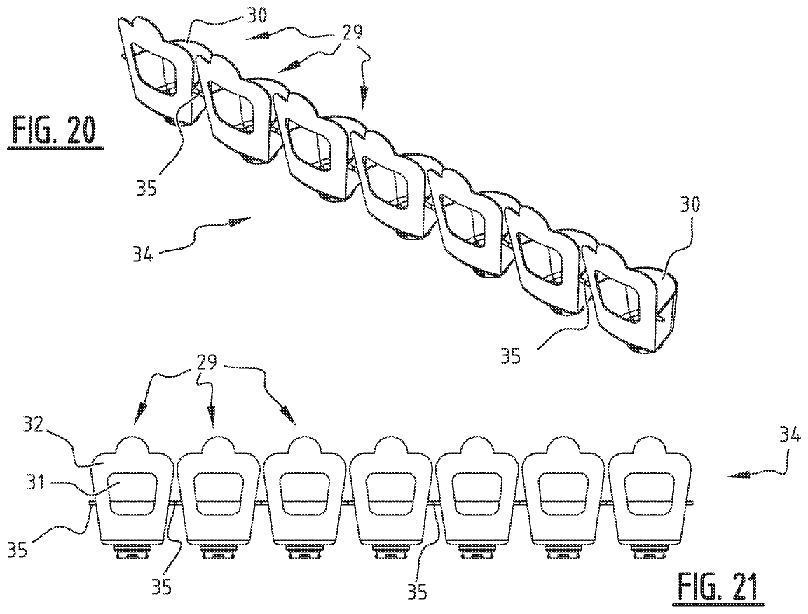

FIGS. 20, 21 show strips of watering inserts.

An example of a wick inserting device 1 is shown in FIG. 1. Wick inserting device 1 comprises an elongate body 2 with a clamp or jaw 3 at one end, and a stop head 4 at an opposing end of the elongate body 2, wherein the stop head 4 is designed to prevent the wick inserting device 1 from being inserted entirely into a plant pot 10 trough hole 9 in a bottom or a wall of the plant pot 10. A wick 8 can be introduced into the clamp or jaw 3 to be engaged therein, in the direction of arrow A in FIG. 1. FIG. 3 shows the wick 8 engaged by the clamp or jaw 3, as it extends from the jaw 3 down towards stop head 4, and possibly beyond stop head 4, in order to draw up water to a position higher in the plant pot 10. The stop head 4 and/or the elongate body at the stop head may comprise a similar clamp or jaw (not shown) to engagingly accommodate wick 8. However, stop head 4 has, in the shown embodiment of FIG. 1, open passages 5 to allow the wick 8 to pass there along unhindered, for example to a water reservoir underneath the plant pot 10, where clamps (not shown) could In principle additionally be provided in or at passages 5. Consequently, a wick 8 can be accommodated in the clamp or jaws 3.

The stop head 4 preferably has transverse dimensions relative to the lengthwise direction of elongate body 2, which transverse dimensions are sufficiently large to prevent the stop head 4 from being pressed through the hole 9 in the bottom or sidewall of a plant pot 10, as shown in FIG. 3. Consequently, in an assembled state, such a stop head 4 will abut against a bottom or side wall of plant pot 10 after elongate body 2 of wick inserting device 1 has been inserted through such the hole 9 in such a plant pot 10.

To prevent the wick inserting device 1 from being retracted out of the plant pot, or falling out of the plant pot, resilient legs 6 are provided on the elongate body 2. These resilient legs 6 are oriented such that these diverge from a connection point with the elongate body 2 towards stop head 4. When the elongate body 2 is pressed through hole 9 in plant pot 10, resilient or flexible legs 6 will be deflected to align with or lie closer to or against the elongate body 2, as a consequence of which the elongate body 2 and the legs 6 will be able to entirely pass through hole 9 in plant pot 10, until stop head 4 abuts against plant pot 10, as shown in FIG. 3, covering hole 9 in the bottom of plan pot 10. After having reached such a position, the flexed or flexible legs 6 will revert back to the position that is depicted in FIGS. 1 and 3 opposite the stop head 4 relative to the surrounding material around hole 9 of plant pot 10, through which hole 9 wick inserting device 1 will then have been inserted into plant pot 10. By appropriate dimensioning of resilient legs 6, of which at least one should preferably be provided, and of stop head 4, inserting devices 1 can be made suitable to be employed for practically all, for example up to or more than 90%, diameters of holes 9 in plant pots 10, irrespective of the plant pot diameters and also practically irrespective of thickness of material layers, from which such plant pots are manufactured, which latter consideration is addressed by appropriate selection of distance between stop head 4 and the free end of resilient or flexible legs 6.

Individually manufactured wick inserting devices, or devices after having been disconnected or even singularized in the above described manner, may be packages individually or in a plurality, and may in strip 11 be connected by cross bars 12 as in the embodiment of FIG. 2. Then, a packaging for consumer sales, for example in the form of a card board holder, may be provided to resemble the configuration of the bottom of plant pot 10 with hole 9, where the wick inserting device may be inserted therein, holding the cardboard holder in place between arms 6 and the stop head 4.

Roughening ribs 7 may be provided on legs 6. Ribs 7 may form hooks extending radially outward further, the nearer to stop head 4. In a situation, where wick inserting device 1 is inserted through hole 9 into plant pot 10, but isn't or can't be inserted to its full extent in which stop head 4 abuts the material of plant pot 10 surrounding hole 9, for example in case of a relatively small sized hole 9, hooked shaped ribs 7 may engage the circumference of hole 9 and prevent wick inserting device 1 from sliding or falling out of hole 9.

When wick 8 is engaged by wick clamp or jaws 3, such a wick 8 may be automatically inserted into plant pot 10 with wick inserting device 1. Wick 8 may be arranged in jaws or clamp 3 before insertion or in the same inserting motion of wick inserting device 1 through hole 9 in the bottom or sidewall of plant pot 10. Inserting wick inserting device 1 into the plant pot 10 can be accomplished manually, but is preferably performed in an automated fashion.

The wick inserting device 1 may be manufactured at least partially from bio-degradable material.

FIG. 2 show a pair of wick inserting devices 1 in a strip 11. Strip 11 may comprise any suitable number of wick inserting devices 1, in particular more than the pair, shown in FIG. 2. Neighbouring wick inserting devices 1 are connected by cross bars 12 which extend radially relative to the longitudinal direction of the elongate bodies 2 and between wick inserting devices 1. Attached to at least some of the cross bars 12 is a transport arm 13. Transport arms 13 extend in at least one direction from the cross bars 12 transverse relative to the longitudinal direction of strip 11. Transport arms 13 may be omitted from a selection of cross bars 12 between wick inserting devices 1 in strip 11.

FIG. 4 shows a strip 16 of mutually connected wick inserting devices 17 in another embodiment, of which in principle only the stop head 4 differs from the embodiment of FIGS. 1-3. FIG. 5 shows a singularized wick inserting device 17, after it has been liberated from the strip 16 of FIG. 4 by a disconnector, here in the form of a cutter blade 18 in FIGS. 4, 6 and 7, where FIGS. 6 and 7 are described in more detail herein below.

Stop head 4 comprises, in the embodiment of FIGS. 4-8, a box shaped head 19 with opposing concave recesses 20 at opposing ends of box shaped head 19, which ends are opposite or transverse, relative to the longitudinal length of the strip 16. The concave recesses 20 allow a stable engagement using the gripper 21 of FIGS. 7 and 8, whereby the orientation of the elongate body 2 is determined, and alignment thereof with hole 9 in plant pot 10 is facilitated and even ensured.

FIG. 9 shows a schematic representation of a system for handling and/or manipulating handling and/or manipulating strips 11, 16 or assemblies of wick inserting devices according to the present disclosure. The system comprises a transporter 22 engaging the strips 11, 16 of wick inserting devices 1, 17 and promoting the strips in a processing direction. Transporter 22 comprises opposing rails 23, as shown more clearly in FIG. 6. The rails are, in this embodiment, U-shaped with the open sides of the rails 23 facing each other. Transport arms 13 are supported in the opposing rails 23, to provide support for later disconnection of individual wick inserting devices 1, 17 to be singularized. Cutter 18, forming an embodiment of a disconnector in the sense of the present disclosure, is arranged at the end of rails 23, as shown in FIGS. 4, 6, 7 and 9. Gripper 21 engages a single one of the wick inserting devices 1, 17 in strip 11, 16 at the end of the transporter 22, as shown in FIGS. 7 and 9. Cutter 18 loops through a down-and-up cutting movement, indicated by arrow B in FIGS. 6 and 7, with the wick inserting device 1, 17 firmly grasped by gripper 21. When cutter 18 loops through its down-and-up cycle, an opposing cutter or anvil may move up-and-down from below the strip 11, 16, to enhance the effectiveness of cutting.

Before or after cutting, the length of wick 8 is provided by a scissors 24, forming the applicator in the sense of the present disclosure, in the relative direction of arrow A in FIGS. 1 and 9. Wick 8 may be provided in wick clamp or jaw 3 before or after cutting with cutter 18. The wick 8 may even be arranged in or on the wick inserting devices at a production origin, and does not need to be provided at the cutting destination of the system of FIG. 9. When the wick is provided after cutting, gripper 21 has to move to an intermediate station for supply of the wick 8.

Gripper 21, forming a manipulator in the sense of the present disclosure, moves with the wick inserting device 1, 17 firmly engaged to plant pot 10 at a final station in the direction of arrow C in FIG. 9, and inserts the wick inserting device 1, 17 with the length of wick 8 into hole 9 of plant pot 10 in the direction of arrow D.

Before inserting one of wick inserting devices 1, 17 into plant pot 10 through hole 9 thereof in FIGS. 3, the one of the wick inserting devices 1, 17 needs to be singularized from strip 11, 16. To this end cross bars 12 are disconnected from elongate bodies 2 of neighbouring wick inserting devices 1, 17, at a position close to the elongate bodies 2 and preferably at the elongate bodies, to prevent that remnants 14 of cross bars 12 form an obstacle when inserting wick inserting devices 1, 17 through holes 9 of plant pots 10. Cross bars 12 may be connected to elongate bodies 2 at a weakening 15, such as a tear line, perforation, thinning portion and the like, to in advance at least approximately and preferably precisely determine a location of disconnection. Additionally or alternatively, a system disclosed herein below for handling and/or manipulating strips 11 of wick inserting devices 1, 17 may comprise an alternative disconnector, such as a scissors, a laser, a saw or the like for disconnecting cross bars 12 from elongate bodies 2 of neighbouring wick inserting devices 1. When weakenings are provided, a disconnector may additionally or alternatively be formed by or comprise the gripper 21 configured to engage one of the wick inserting devices 1, 17 in and to be singularized from strip 11, for example at its stop head 4, and twist an engaged one of the wick inserting devices 1, 17 and thereby break the connection of the one of the wick inserting devices to the cross bar at the weakening there between. Likewise, after a wick inserting device 1, 17 has been disconnected from strip 11, 16, a cross bar 12 remains extending from strip 11, 16 and can be removed in similar fashion, using gripper 21 to engage cross bar 12 and twisting it to disconnect cross bar 12 from the next wick inserting device 1, 17 at the weakening, to make the next wick inserting device 1, 17 available to be singularized. When a weakening is omitted, a gripper may provide a sturdy hold on the wick inserting device 1, 17, and prevent the wick inserting device from falling away. Either way, by providing a gripper 21 to engage the wick inserting device 1, 17 to be singularized, swift further processing/handling/manipulation of the wick inserting device 1, 17 is achieved to, for example, in arbitrary order: move singularized wick inserting device 1, 17 to a plant pot 10 and apply a length of wick 8. When the wick inserting device 1, 17 is at plant pot 10 and provided with the length of wick 8 in the wick clamp or jaw 3 thereof, gripper 21 may align the end thereof with the wick clamp or jaw 3 to or with hole 9 in the bottom or sidewall of plant pot 10, and insert elongate body 2 of wick inserting device 1 through hole 9.

Cross bars 12 may be disconnected from elongate bodies 2 of neighbouring wick inserting devices 1 in strip 11 simultaneously at both ends, which requires at least two cutters as shown in FIG. 9, or one end at a time, whereby the system may comprise a single cutter. Remnants of cross bars 12 may remain, such as stumps 14 in FIGS. 1 and 3. However, these should be small enough not to form obstacles, when inserting wick inserting devices 1, 17 into plant pots 10 through holes 9 in bottoms or sidewalls of the plant pots.

Transport arms 13 and/or stop heads 4 may be engaged by a transporter of the aforementioned system for handling and/or manipulating strips 11 of wick inserting devices 1, and by a holder or gripper 21 for steadying/immobilizing strip 11 of wick inserting devices 1 when the cutter 18 thereof is in operation. However, the transport arms 13 may be omitted entirely, if the system discussed herein above has a transporter 23 that focusses entirely on head stops 4 instead of transport arms 13.

In order to simplify the process of inserting wick inserting devices 1, 17 into holes 9 of plant pots 10, a punch may be provided to make hole 9. When plant pots 10 are pre-provided with holes 9, the system may detect the positions of holes 9, for which the system may have a vision system, like a camera and image processor, for example, and rotate plant pots 10 to present holes 9 at predetermined positions. However, this may be considered to contribute to complexity and costs, and although the preceding option is by no means excluded, a further solution is to a supply of the plant pot in a sequence with preceding and following plant pots, all with the hole thereof at a predetermined position, to allow the manipulator to orient the wick inserting device on the hole at the predetermined position.

As shown in FIGS. 10 and 11, the supply may comprise a conveyor for moving the plant pot in a direction of cross arrow E to a location where the gripper 21 inserts wick inserting devices in the direction of arrow D into plant pots, and FIGS. 12, 13 show exemplary plant pots in isolation in a side and a top-down view, respectively. The supply comprises at least one transport tray 25 with at least one accommodation 26 for the plant pot 10. The accommodation comprises an articulated plant pot support at the bottom of the accommodation. The plant pot 10 is correspondingly articulated to rotationally orient the plant pot 10 based on the articulation of the support at the bottom of the accommodation 26 and the corresponding articulation of the plant pot 10. Thereby hole 9 may be positioned at a predetermined position for the gripper 21 to insert a wick inserting device into each of the pots 10 in the tray 25, in the direction of arrow D. A bottom of the accommodation 26 in tray 25 has an opening, through which gripper 21 inserts a wick inserting device into each plant pot 10. The supply may move tray 25 in all directions of the cross arrow E to move tray 25 over the predetermined position, which is associated with a location of arrow D to allow the gripper 21 to insert wick inserting devices 1, 17 sequentially into all pots 10 in tray 25, at the predetermined position. Alternatively, the gripper may be part of a robot arm (not shown), where tray 25 may be immobile, while the robot arm passes along positions of accommodations 26 and inserts a wick inserting device 1, 17 into each pot 10.

More in particular the articulation may comprise at least one bulge 27 protruding from the bottom of the accommodation 26 where pots 10 comprise a correspondingly formed indentation 28. When pots 10 are inserted into accommodations 26, this aligns holes 9 in bottoms of plant pots to be aligned with an inserting position.

In the embodiment of FIG. 14, the pot 10 has an articulation running along the side wall up to an upper rim. Accommodation 26 of the tray in FIGS. 10, 11 may have a corresponding articulation for aligning pot 10, at least at the bottom of accommodation 26.Since the articulation formed by indentation 28 of pot 10 extends up to the rim of pot 10, a support is defined, which may gainfully be employed to carry a watering insert 29, as shown in in isolation (without pot 10 of FIG. 14) in several views in FIGS. 15-19. In case pot 10 is an inner pot, to be arranged in a outer pot in a state of use, the insert may allow introducing replenishing a water supply in the outer pot. Regardless of whether pot 10 is an inner pot, the insert 29 may comprise a water receiving and/or distributing reservoir 30, and in connection therewith water distributing channels (not shown) to distribute water from the reservoir over a top surface of substrate in pot 10. Inside reservoir 30, a cross hair element 33 is provided break a water flow from a pouring tout of a watering can. At a radial outer wall 32, the insert 29 comprises a pouring opening 31, to allow insertion therein of a pouring tout of a watering can. The radial wall 32 bridges the opening 31 to keep the leaves away from the pouring tout. This allows pouring water into water receiving and/or distributing reservoir 30 of insert 29, with no or at least less hindrance from leaves of plants growing over sides of pot 10, and consequently less water spillage. Furthermore, the outward facing radial wall 32 may be employed to carry and deliver consumer information, for example about the plant and its requirements for care, as well as manufacturer information. Watering inserts 29 may be manufactured in a strip 34, shown in FIGS. 20, 21, much alike the wick inserting devices in the embodiment of FIG. 2. The watering inserts 29 are connected through cross bars 35, which may be severed half-way, or completely removed from both neighbouring watering inserts 29, like the wick inserting devices 1 in strips of FIGS. 2, 4, 6 et cetera. Further, water inserts 29 are designed in the shown embodiment, to be nestable, i.e. inserted the one into the other. Regardless of supply in nested or strip shape, automated handling and placement of watering inserts 29 in or on plant pot 10 may be achieved, much alike the automatic handling and processing of the strips of wick inserting devices according to FIG. 2.

Based on the above description of specific and particular embodiments of the present disclosure, the scope of protection according to the appended claims has been substantiated, whereas clearly additional and/or alternative embodiments are possible, feasible and potentially desirable within the scope of protection according to those appended claims. Features of the specific embodiments can not and should not result in limitation of the scope of protection thereto, unless defined in independent claims, whereas even the features defined in the appended independent claims can be replaced by obvious alternatives. The main objective of the present disclosure is to provide a wick inserting device that is better suited to automated handling, where prior art devices less suitable therefore. Through the teaching of the present disclosure, a considerable improvement is provided.

1. A wick inserting device comprising:
an elongate body dimensioned to pass through a hole in a bottom or a sidewall of a plant pot;
a wick clamp or jaw at one end of the elongate body configured to engage a length of a wick; and
a stop head at an opposing end of the elongate body.

2. The wick inserting device according to claim 1, wherein the stop head comprises at least one passage to allow wick to pass there along.

3. The wick inserting device according to claim 1, further comprising an additional wick clamp or jaw at the head stop and configured to engage another portion of the length of the wick.

4. The wick Wick inserting device according to claim 1, wherein the stop head is larger, as measured transverse to the lengthwise direction of the elongate body, than the elongate body, and wherein the transverse size of the stop head is sufficiently large to cover the hole and thereby prevent the stop head from being pressed through the hole in the bottom or sidewall of the plant pot.

5. (canceled)

6. The wick inserting device according to claim 1, wherein the elongate body comprises at least one resilient leg, and wherein the resilient leg diverges from a connection point with the elongate body towards stop head.

7. (canceled)

8. The wick inserting device according to claim 6, wherein the resilient leg is sufficiently flexible to deflect and align with or lie closer to or against the elongate body, for the resilient leg to entirely pass the through hole in the plant pot, and to flex or revert thereafter back towards the undeflected position thereof.

9. The wick inserting device according to claim 6, wherein the resilient leg comprises at least one outward oriented rib, and wherein the rib forms a hook.

10. (canceled)

11. The wick inserting device according to claim 1, wherein at least one of the elongate body; the wick clamp or jaw; and the stop head, or any further component, is at least partially manufactured from a bio-degradable material.

12. An assembly, comprising:
a plant pot having a hole in a bottom or a sidewall thereof;
a wick inserting device according to claim 1, of which the elongate body is inserted at least substantially fully through the hole for the stop head to at least approximate and preferably cover the hole; and
a wick engaged by the wick clamp or jaw at the one end of the elongate body, and extending from the wick clamp or jaw at least towards the stop head.

13. An assembly, comprising at least a pair of the wick inserting devices according to claim 1, wherein neighbouring wick inserting devices are connected by a cross bar, which extends radially relative to the longitudinal direction of the elongate bodies and between wick inserting devices.

14. The assembly according to claim 12, wherein attached to at least one of the cross bars is a transport arm, and wherein the transport arm extends in at least one direction from the cross bars transverse relative to the longitudinal direction of strip.

15. (canceled)

16. The assembly according to claim 12, wherein the cross bar is disconnectable from both elongate bodies of the neighbouring wick inserting devices, at a position close to the elongate bodies and preferably at the elongate bodies, to prevent remnants of the cross bar from forming an obstacle when inserting the wick inserting devices through holes in bottoms or sidewalls of plant pots, wherein the cross bar is connectable to elongate bodies at a weakening to in advance at least approximately determine a location of disconnection.

17. A system for handling and/or manipulating assemblies of wick inserting devices according to claim 12, comprising:
a transporter engaging the assemblies of wick inserting devices and promoting the assemblies towards a processing direction;
a disconnector configured to singularize neighbouring wick inserting devices; and
a manipulator configured to engage an individual singularized wick inserting device and insert it with the wick into a hole in a bottom or a side wall of a plant pot.

18. The system according to claim 17, further comprising an applicator configured to apply a length of wick to at least one of the wick inserting devices

19. (canceled)

20. The system according to claim 17, wherein the manipulator comprises a gripper configured to engage a wick inserting device.

21. The system according to claim 17, further comprising at least one of:
a punch to strike the hole in the bottom or the sidewall of the plant pot at a predetermined position;
a rotator to turn the plant pot and to thus position the hole at a predetermined position; and
a supply of the plant pot in a sequence with preceding and following plant pots,
all with the hole thereof at a predetermined position, to allow the manipulator to orient the wick inserting device on the hole at the predetermined position.

22. The system according to claim 20, wherein the supply comprises a conveyor with an articulated plant pot support wherein the plant pot is correspondingly articulated to rotationally orient the plant pot based on the articulation of the support and the corresponding articulation of the plant pot and position the hole at the predetermined position.

23. The system according to claim 21, wherein the conveyor comprises at least one transport tray with at least one accommodation for the plant pot and the accommodation comprises the articulation.

24. The system according to claim 21, wherein a side wall of the pot comprises the articulation up to an upper rim, and defines a support for a watering insert.

25. A plant pot according to claim 21, comprising a bottom; at least one side wall; and a hole in at least one of the bottom and the side wall, wherein at least one of the bottom and the side wall of the plant pot is articulated and wherein the hole is arranged at a predetermined position relative to the articulation, wherein rotational orientation of the plant pot based on the articulation enables presentation of the hole at a predetermined position.

26-27. (canceled)
